(19) United States
(12) Patent Application Publication
(10) Pub. No.: US 2002/0010996 A1
(43) Pub. Date: Jan. 31, 2002

(54) Method and apparatus for installing and removing bearing races

(75) Inventor: Garry A. Sarver, Belvidere, IL (US)

Correspondence Address: LEYDIG VOIT & MAYER, LTD, 6815 WEAVER ROAD, ROCKFORD, IL, 61114-8018, US

(73) Assignee: Fulcrum Tools, Inc., Loves Park, IL

(21) Appl. No.: 09/803,287

(22) Filed: Mar. 9, 2001

Related U.S. Application Data
(63) Continuation of application No. 09/491,031, filed on Jan. 25, 2000.
Application No. 09/491,031 is a continuation-in-part of application No. 09/094,134, filed on Jun. 9, 1998, now Pat. No. 6,212,775.

(51) Int. Cl. B23P 19/02

(52) U.S. Cl. 29/525; 29/256

(57) ABSTRACT

A blind hole bushing puller and method, wherein the puller comprises: a rectangular cross block having a first end-portion and a second end portion, a pair of elongated leg screws, a circular bushing insert, and a bolt with a matching washer and a nut. Each of the end-portions of the cross block have a threaded leg hole formed therethrough, the cross block also has a centrally located unthreaded cross block hole. One of the leg screws passes through one of the threaded leg holes, and the other leg screw passes through the other threaded leg hole. The bushing insert has a centrally located unthreaded bushing insert hole and is sized to snugly fit about an inside diameter of the bushing. The bolt is sized to pass through the bushing insert hole and the cross block hole with a head of the bolt being positioned adjacent an upper portion of the bushing insert. The bolt head is sized slightly larger than the bushing insert hole and has a sufficient length so as to allow a lower portion of the bolt to extend beyond a lower end of the cross block hole. The bolt is securable to the cross block by the washer and the nut. Whereby when the bushing insert is securely attached within the bushing and the bolt is secured through the bushing insert and the cross block, the leg screws can be tightened in a direction wherein an upper portion of the leg screws comes into engagement with a housing portion supporting the bushing. The leg screws can then be further tightened in an alternating fashion thereby pulling and eventually removing the bushing from the hole.

### CROSS-REFERENCE TO RELATED PATENT APPLICATIONS

This patent application is a continuation of copending U.S. patent application Ser. No. 09/491,031, filed Jan. 25, 2000, [pending], the entire disclosure of which is incorporated by reference, which is a continuation-in-part of copending U.S. patent application Ser. No. 09/094,134, filed Jun. 9, 1998, [pending], the entire disclosure of which is also hereby incorporated by reference.

### FIELD OF THE INVENTION

The present invention relates generally to a new and improved method and apparatus for pulling bushings or bearings. More specifically the present invention provides a method and apparatus for pulling bushings or bearings quickly and easily from a hole wherein the bushing or bearing is tightly positioned within the hole and requires special tools and/or methods for removing the bushing or bearing from the hole, particularly when the bushing or bearing is situated in a blind hole. For reference purposes, the term bushing will be used synonymously with the term bearing since the method and apparatus of the present invention applies to the removal of both bushings and bearings similarly situated.

### BACKGROUND OF THE INVENTION

Various types of bushings and bearings can be frequently mounted in situations where the bushing can only be accessed from one side, this is commonly known as a blind hole. Often times, as in the case of a standard bushing used for a tree spade, there is no space lieft behind the bushing in order to leverage a damaged bushing from the hole. Furthermore, conventional type bushing pullers, even blind hole bushing pullers cannot pull bushing from a blind hole if there is no gap present behind the bushing, or if there is no bushing mount so as to grab the bushing with standard type bushing pullers.

The conventional method of removing a bushing that is press fit into a blind hole would be to cut off the back end or grease cap of the blind hole with a torch. After the back end of the blind hole is cut off, then the damaged bushing is then carefully cut lengthwise with a torch, while at the same time being careful so as to not damage the bushing boss supporting the bushing. The damaged bushing can then be forced out from the back end with a tool and/or a hammer. After the bushing is removed, the lining within the bushing boss would need to be inspected for damage and properly cleaned before a new bushing can be inserted. Furthermore, the grease cap or the back end of the blind hole would need to be welded back on and a new bushing can then be inserted.

The entire procedure of removing the damaged bushing using this conventional method can take approximately 30 minutes to an hour for each damaged bushing. This can place a machine that uses multiple bushings out of service for a few days. We have therefore provided a bushing removal tool and method that can remove damaged bushings quickly and easily in about five minutes without a concern of causing any other damage to the bushing boss supporting the bushing.

There have been various types of bushing and bearing pullers available in the marketplace, but none have gained widespread acceptance because of their difficulty of use and the inability for quickly an easily removing bushing or bearings, particularly from a blind hole. In addition, other types of bushing pullers require additional time to remove the bushing/bearing, do not provide flexibility and ease of use of our puller and do not employ the particular method that we have developed in removing bushings and bearings from a bushing boss or a hole, especially when the bushing/bearing is situated in blind hole.

These and other types of pullers used in the past do not offer the flexibility and inventive features of our method and apparatus for pulling bushings and bearings. As will be described in greater detail hereinafter, the method and apparatus of the present invention differs form those previously proposed.

### BRIEF SUMMARY OF THE INVENTION

It has recently been realized concept disclosed in the present invention can be implemented in a wider variety of applications for a variety of press fit parts including for example bearing races (as disclosed herein), bearing cups as is demonstrated in U.S. patent application Ser. No. 09/491,031 (the entire disclosure of which is hereby incorporated by reference), wheel studs of truck wheel hubs, to name a few. The invention resolves long felt needs for easier installation and removal of press fit parts. The invention is applicable to both installation and removal of press fit parts. Moreover, the invention can be used not only to pull press fit parts but also to push press fit parts with the tool. For example, in the case of wheel studs, the wheel studs may be directly connected to the cross block by screwing the threaded end of the wheel stud into a central hole of the cross block between the leg screws or more preferably by extending the threaded end of the wheel stud through a central hole in the cross block between leg screws and threadingly connecting or attaching the threaded end of the wheel stud to a nut that engages the opposite side of the support body of the cross block (on the side opposite the head end of the wheel stud). Depending upon the way in which the leg screws are turned, the wheel studs can either be pushed or pulled with the tool.

This patent application is intended to tie the many applications together with broad and meaningful patent coverage sufficiently generic to cover more of the various applications. Accordingly the present invention is directed toward a method of translating a press fit part in a cavity defined in an apparatus. The method comprises arranging a tool on the apparatus. The tool includes a cross block and spaced apart leg screws. The leg screws threadingly engage the cross block. The cross block is attached to the press fit part at a location between the leg screws along a longitudinal axis such that the cross block is substantially aligned on a traverse axis perpendicular to the longitudinal axis. After the attaching and arranging step, the first and second leg screws are alternately actuated causing the cross block to rock about a traverse axis and translate the press fit part along the longitudinal axis relative to the cavity.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an exploded perspective view of our bushing puller embodying important features of our invention;

FIG. 2 is a cross-sectional side view of our bushing puller prepared to pull a bushing from a bushing boss or a hole;

FIG. 3 is a top plan view of the bushing puller insert used in our invention;

FIG. 4 is a side view of our bushing puller insert shown in FIG. 3;

FIG. 5 is a partial cross-sectional side view illustrating the positioning of our bushing puller insert within a bushing that is to be pulled from a hole;

FIG. 6 is a cross-sectional side view illustrating our method of pulling a bushing from a hole using our bushing pulled;

FIG. 7 is a cross-sectional side view further illustrating our method of pulling a bushing from a hole using our bushing puller;

FIG. 8 is a cross-sectional side view illustrating how a bushing is finally removed from a hole using our bushing puller and method;

FIG. 9 is an exploded perspective view of another embodiment of our bushing puller illustrating further important features of our invention wherein our bushing puller is adjustable for pulling bushings of varying sizes; and

FIG. 10 is a side view of our bushing puller shown in FIG. 9

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

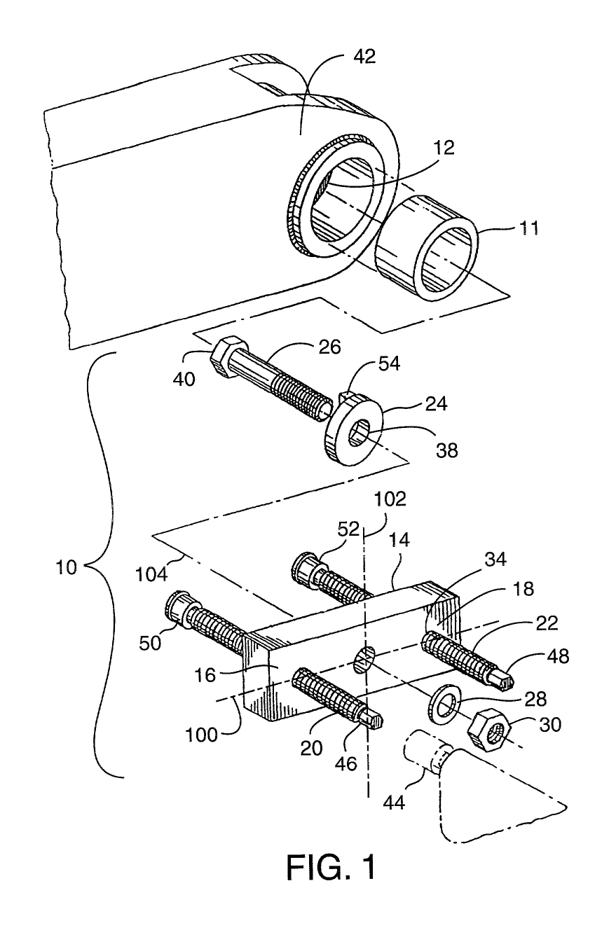

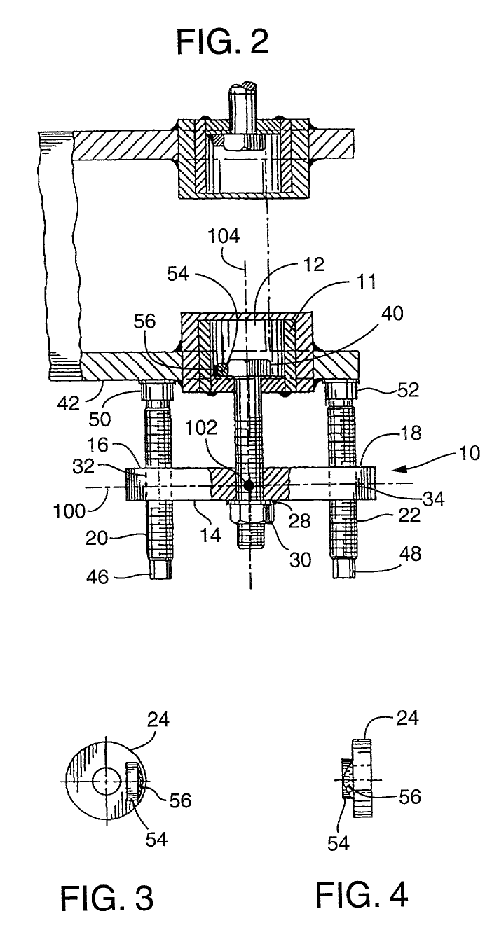

Referring now to the drawings, FIGS. 1 and 2 show our bushing/bearing puller 10 used for pulling a bushing 11 and/or a bearing from a blind hole 12. Our bushing puller 10 comprising: a rectangular cross block 14 having a first end-portion 16 and a second end portion 18, a pair of elongated leg screws 20, 22, a circular bushing insert 24, and a bolt 26 with a matching washer 28 and a nut 30.

Each of the end-portions 16, 18 of the cross block 14 have a threaded leg hole 32, 34 formed therethrough, and a centrally located unthreaded cross block hole 36 all of which are aligned along a longitudinal axis 100. The cross block 14 can be made of steel, aluminum or any other type of material durable and strong enough to perform the function of pulling a bushing tightly secured within a blind hole.

Each of the leg screws 20, 22 passes through and is threadingly engaged with one of the threaded leg holes 32, 34. The bushing insert 24 has a centrally located unthreaded bushing insert hole 38 and is sized to fit snugly about an inside diameter 5 of the bushing 11. The bolt 26 is sized to pass through the bushing insert hole 38 and the cross block hole 36 with a head 40 of the bolt being positioned adjacent an upper portion of the bushing insert 24.

The bolt head 40 is sized slightly larger than the bushing insert hole 38 and has a sufficient length so as to allow a lower portion of the bolt 26 to extend beyond a lower end of the cross block hole 36. The bolt 26 is securable to the cross block 14 by the washer 28 and the nut 30. When the bushing insert 24 is securely attached within the bushing 11 and the bolt 26 is secured through the bushing insert 24 and the cross block 14, the leg screws 20, 22 can be tightened in a direction wherein an upper portion of the leg screws comes into engagement with a housing portion 42 supporting the bushing 11. The leg screws 20, 22 can then be further tightened in an alternating fashion thereby pulling and eventually removing the bushing 11 from the hole 12.

In order to pull a 2 ½ inch bushing from a blind hole, excellent results can be obtained when: the cross block 14 is made of steel being one inch thick, two inches wide and six inches long, the threaded leg holes have a 9/16 inch diameter with a ⅝ inch thread (18 threads per inch), and the unthreaded cross block hole has a 9/16 inch diameter; and the bushing insert 24 is ½ inch thick with a 9/16 inch center hole, and the diameter is sized to be approximately 0.002 inches less than the inner diameter of the bushing, with a tolerance of +/−0.0001 inches.

In order to make it easy to tighten the leg screws 20, 22 with a high impact wrench 44 or a standard wrench, we have provided hexagonal heads 46, 48 on the ends of the leg screws. We have also provided leg ends 50, 52 that are pivotally positioned at an upper end of the leg screws 20, 22. The leg ends 50, 52 are designed to have a flat upper surface for engagement with the housing portion 42 supporting the bushing 11 that is to be removed from the blind hole 12.

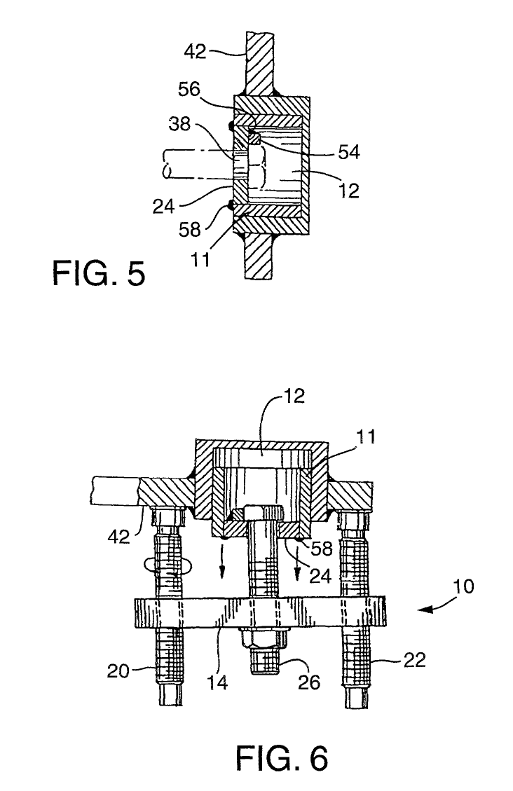

In order to tightly secure the bolt 26 through the bushing insert 24 and the cross block 14, we have alternatively added key stock 54 (FIGS. 3-5) that is securely attached at an upper surface of the bushing insert 24. The key stock 54 can be secured in place with a weld 56. The key stock 54 is positioned on the bushing insert 24 in such a way so as to prohibit the bolt head 40 from turning when the bolt 26 has been inserted all the way through the bushing insert 24, thereby allowing a use to securely tighten the bolt 26 to the cross block 14, thereby keeping the bolt from unnecessarily rotating as one is trying to tighten the bolt 26 down.

FIGS. 6-8 illustrate our method of using our bushing puller 10 for pulling a worn bushing 11 from a socket or a blind hole 12 on a tree spade. First a threaded bolt 26 is extended through the bushing insert 24. Then the bushing insert 24 is welded 58 to the bushing. A bushing removal tool 10 is then secured to the bolt. Alternative forces are then applied, first to the tree spade 42 at one side of the worn bushing 11 and then another force to second and opposite side of the worn bushing 11. This process of applying alternating forces is repeated to rock the cross block 14 about a first transverse axis 102 that is perpendicular to the longitudinal axis 100 and simultaneously translate the cross block 14 linearly along a second transverse axis 104 that is mutually perpendicular with the longitudinal axis 100 and first transverse axis 102 until the worn bushing 11 is displaced from the tree spade socket 12. A new bushing can then be inserted into the tree spade socket to complete the reconditioning of the tree spade.

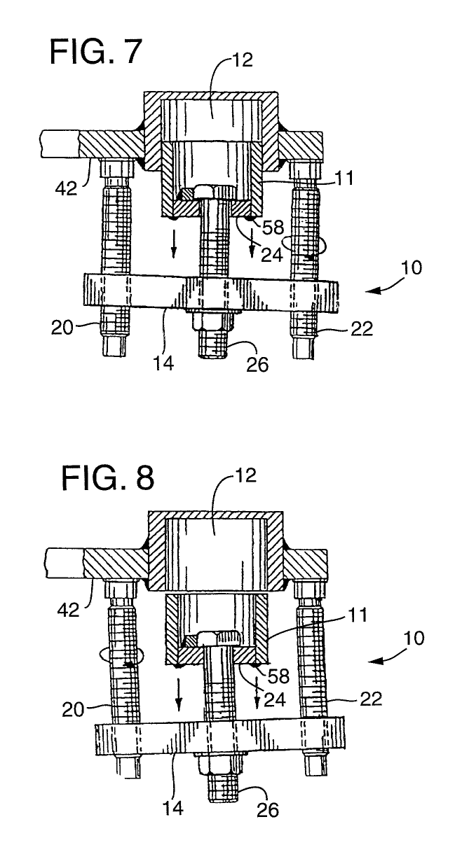

More specifically, FIGS. 6-8 illustrate how the bushing 11 is walked out when the leg screws 20, 22 are tightened in an alternating fashion to pull and remove the bushing 11 from the blind hole 12. FIG. 6 shows how the bushing 11 is slightly pulled from the blind hole 12 and the cross block 14 is slightly angled in relationship to the housing 42 supporting the bushing 11 as the leg screw 20 is tightened. FIG. 7 shows the next step how the bushing 11 is pulled even more from the blind hole 12, and the cross block 14 is now slightly angled the other way in relationship to the housing 42 as the leg screw is tightened. FIG. 8 finally shows how the bushing 11 is finally removed from the blind hole 12 as the leg screws 20, 22 have been tightened in a continuous alternating fashion so as to “walk out” the bushing 11 from the blind hole 12.

Excellent results can be obtained when the bushing insert 24 is securely attached within the bushing 11 by welding 58 the bushing insert 24 directly to the bushing 11. It is generally common for facilities or businesses that perform repairs on equipment that requires a replacement of press fit bushings to have a welding gun readily available for use.

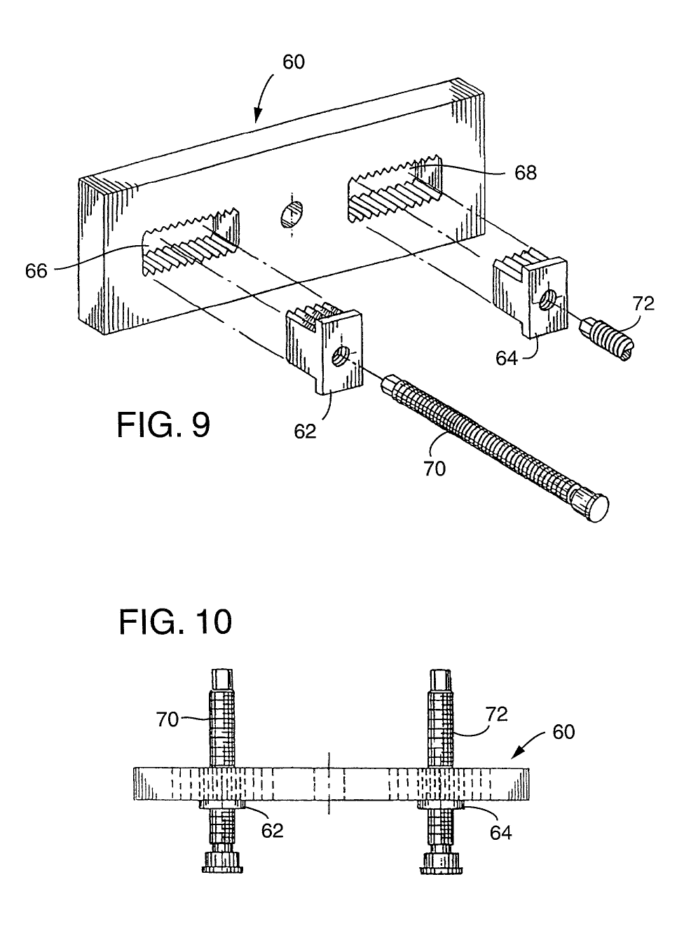

We have also provided a modified version of our bushing puller in order to accommodate the removal of bushings of various sizes. As can be seen in FIGS. 9 and 10, this bushing puller 60 has adjustable leg hole inserts 62, 64 that are sized to engage a widened ridged hole 66, 68 so as to allow for adjustment of the spread of the leg screws 70, 72.

As various possible embodiments may be made in the above invention for use for different purposes and as various changes might be made in the embodiments and method above set forth, it is understood that all of the above matters here set forth or shown in the accompanying drawings are to be interpreted as illustrative and not in a limiting sense.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitle

What is claimed is:

1. A method of translating a press fit part in a cavity defined in an apparatus, comprising:
arranging a tool on the apparatus, the tool including a cross block, spaced apart leg screws, the leg screws threadingly engaging the cross block;
attaching the cross block to the press fit part at a location between the leg screws along a longitudinal axis wherein the cross block is substantially aligned on a traverse axis perpendicular to the longitudinal axis; and
alternately actuating the first and second leg screws causing the cross block to rock about a traverse axis and translate the press fit part along the longitudinal axis relative to the cavity.

2. The method of claim 1 wherein the tool further comprises a bolt, the bolt having a first end supported by the cross block between the leg screws and a second end engaging the press fit part, wherein the step of attaching comprises tightening the bolt.

3. The method of claim 2 wherein the press fit part is a bushing having a central through-hole, further comprising inserting the bolt through the central through-hole.

4. The method of claim 3 further comprising arranging a bushing insert on the bolt at the second end for engaging the press fit part.

5. The method of claim 4 further comprising threading the bolt on a nut at the first end engaging the cross block.

6. The method of claim 1 further comprising welding the connection portion to the press fitted part.

7. The method of claim 1 further comprising accommodating the rocking about the axis through a pivot joint in the tool.

8. The method of claim 1 wherein the pivot joint comprises pivot foots at each ends of the leg screws.

9. The method of claim 1 wherein the step of actuating further comprises alternately connecting a power tool to ends of the legs screws.

10. The method of claim 1 wherein the cross block includes adjustable leg hole inserts and a support body, the leg hole inserts being selectively movable along the transverse axis relative to the support body, the leg hole inserts threadingly engaging the leg screws, further comprising selectively positioning the leg hole inserts along the traverse axis to selectively space the leg screws.

11. The method of claim 1 further comprising pulling the press fit part through alternately actuating the leg screws.

12. The method of claim 1 further comprising locating ends of the legs screws in contact with the apparatus and tightening the attachment between the cross block and the press fit part prior to the alternately actuating step such that the leg screws support the tool in spaced relation to the apparatus.
